(19) United States
(12) Patent Application Publication
(10) Pub. No.: US 2025/0189066 A1
(43) Pub. Date: Jun. 12, 2025

(54) METHOD OF TREATING CRACKS IN A TUBE

(71) Applicant: Louisiana Tech Research Corporation; Of Louisiana Tech University Foundation, Inc., Ruston, LA (US)

(72) Inventor: Henry E. Cardenas, Ruston, LA (US)

(21) Appl. No.: 18/978,825

(22) Filed: Dec. 12, 2024

Related U.S. Application Data
(60) Provisional application No. 63/608,960, filed on Dec. 12, 2023.

(51) Int. Cl. F16L 55/1645; C25D 7/04; C25D 17/00; C25D 17/10; C25D 21/12

(52) U.S. Cl. CPC F16L 55/1645; C25D 7/04; C25D 17/002; C25D 17/10; C25D 21/12

(57) ABSTRACT

Apparatus and methods for electroplating interior walls of a pipe. The apparatus includes a power and drag line, a tail connected to a first end of the power and drag line, a head connected to the power and drag line, and a plethora of spacers connected to the power and drag line between the tail and the head. A second end of the power and drag line extends out from a side of the head opposite the plethora of spacers. When the apparatus is pulled through a pipe by the second end of the power and drag line, the apparatus is configured to polarize a treatment fluid within walls of the pipe to draw ions within the treatment fluid into cracks in the walls of the pipe.

### TECHNICAL FIELD

The present disclosure generally relates metal fatigue and a treatment to stop crack growth and prevent leaks and failures in small tube systems.

### BACKGROUND

Unless otherwise indicated herein, the materials described in this section are not prior art to the claims herein and are not admitted as being prior art by inclusion in this section. Fatigue is responsible for at least 50% of all mechanical and 90% of all metallic failures. Fatigue cracks often start at stress concentrations, and without timely and appropriate remediation, tend to exhibit relatively fast propagation that leads to property damage and sometimes serious accidents. The effort to mitigate metal fatigue generally involves control of stress, scheduling of defect inspections, estimating when a given crack will start growing, and determining when it will grow to a dangerous length. These tasks are hindered by small cracks that tend to be difficult and costly to detect. Many crack prone areas are relatively inaccessible. Current technology in the art involves a visual camera inspection with a mechanical removal of cracks followed by welding replacement tube in place.

### SUMMARY

Existing challenges associated with the foregoing, as well as other challenges, are overcome by the presently disclosed electroplating apparatus and method to treat pipeline cracks remotely, even those that are too small to be detected by borescope cameras (or other non-destructive inspection methods and technologies).

One embodiment of the present disclosure is an apparatus for electroplating interior walls of a pipe. The apparatus includes a power and drag line, a tail connected to a first end of the power and drag line, a head connected to the power and drag line, and a plethora of spacers connected to the power and drag line between the tail and the head. A second end of the power and drag line extends out from a side of the head opposite the plethora of spacers. When the apparatus is pulled through a pipe by the second end of the power and drag line, the apparatus is configured to polarize a treatment fluid within walls of the pipe to draw ions within the treatment fluid into cracks in the walls of the pipe.

In aspects, the head includes a first soft poly ball and a leading reference electrode, and the tail includes a second soft poly ball and a following reference electrode.

In aspects, a voltmeter connected between signal lines of the apparatus and walls of the pipe determines a first voltage difference between the leading reference electrode and the pipe walls and a second voltage difference between the following reference electrode and the walls of the pipe.

In aspects, an efficiency and effectiveness factor of the apparatus is determined based on a difference between the first voltage difference and the second voltage difference.

In aspects, the plethora of spacers are each formed from a non-conducting material and prevent the power and drag line from making direct contact with the walls of the pipe.

In aspects, the plethora of spacers are porous and allow the treatment fluid to flow through the spacers.

In aspects, the plethora of spacers are in the shape of offset wedges.

In aspects, the head, tail and spacers are sized based on an interior diameter of the pipe.

Another embodiment of the present disclosure includes an electroplating system for treating cracks in interior walls of a pipe. The system includes a treatment fluid and an electroplating apparatus. The electroplating apparatus includes a power and drag line, a tail connected to a first end of the power and drag line, a head connected to the power and drag line, and a plethora of spacers connected to the power and drag line between the tail and the head. A second end of the power and drag line extends out from a side of the head opposite the plethora of spacers. When the apparatus is pulled through the pipe by the second end of the power and drag line, the apparatus is configured to polarize the treatment fluid within walls of the pipe to draw ions within the treatment fluid into cracks in the walls of the pipe.

In aspects, the treatment fluid includes ions from one or more metallic salts.

In aspects the system further includes a processor, and a machine learning algorithm is executed by the processor to optimize the system.

Another embodiment of the present disclosure is a method of treating cracks in interior walls of a pipe. The method includes filling the pipe with a treatment fluid and pulling an electroplating apparatus through the treatment fluid within the walls of the pipe. The electroplating apparatus includes a power and drag line, a tail connected to a first end of the power and drag line, a head connected to the power and drag line, and a plethora of spacers connected to the power and drag line between the tail and the head. The method includes polarizing, by the electroplating apparatus, the treatment fluid within the walls of the pipe to draw ions within the treatment fluid into cracks in the walls of the pipe.

In aspects, the head includes a first soft poly ball and a leading reference electrode, and the tail includes a second soft poly ball and a following reference electrode, and the method further includes determining, by a voltmeter, a first voltage difference between the leading reference electrode and the pipe walls and determining, by the voltmeter, a second voltage difference between the following reference electrode and the walls of the pipe.

In aspects, the method further includes determining an efficiency and effectiveness factor of the electroplating apparatus based on a difference between the first voltage difference and the second voltage difference.

In aspects, the method further includes executing, by a processor, a machine learning algorithm to optimize the electroplating apparatus.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an example system to treat cracks in a straight length of tube in accordance with the present disclosure;

FIG. 2 illustrates an example system to treat cracks in a curved length of tube in accordance with the present disclosure;

FIG. 3 is a block diagram of a machine learning network with inputs and outputs of a deep learning neural network in accordance with aspects of the present disclosure;

FIG. 4 is a diagram of layers of the machine learning network of FIG. 3 in accordance with aspects of the present disclosure; and

FIG. 5 illustrates a flow diagram for an example method for treating cracks in interior walls of a pipe in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

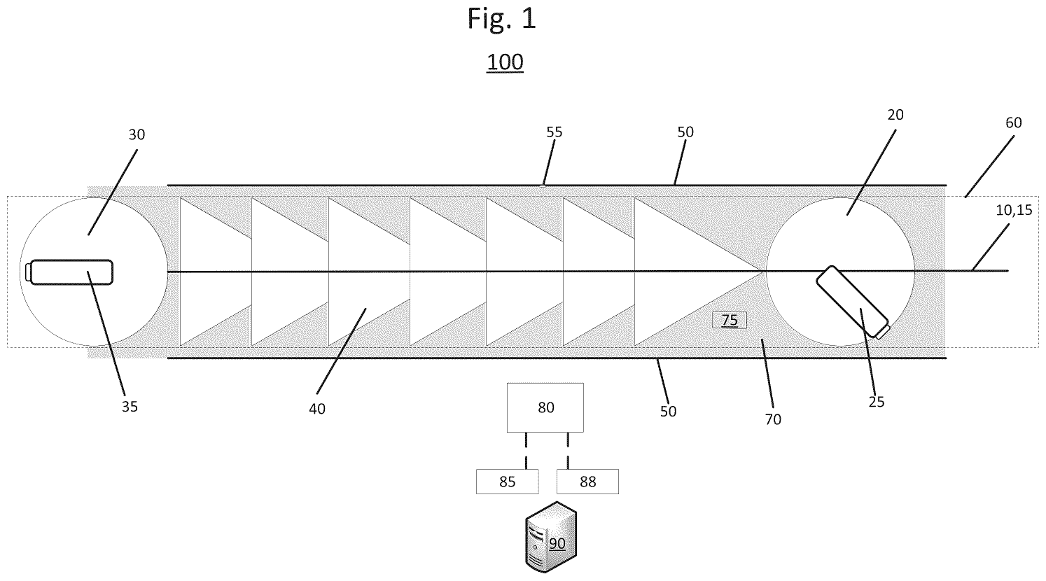

FIG. 1 illustrates an example system to treat cracks in a straight length of tube arranged in accordance with at least some embodiments described herein. As discussed in more detail below, treatment of a metal tube or pipe using system 100 may mitigate metal fatigue by stopping the growth of pipeline cracks remotely, even cracks which are too small to be detected by borescope cameras (or other non-destructive means of inspection).

System 100 may include an electroplating apparatus 60, a treatment fluid 70, and pipe walls 50. Electroplating apparatus 60 may include a power and drag line 10, a head 20, tail 30, and spacers 40. A first end of power and drag line 10 may be connected to tail 30 and head 20 may be connected to power and drag line 10 at a distance from tail 30. A distance from head 20 to tail 30 may range from about 1 inch to about 1200 inches. A plethora of spacers 40 may be connected to power and drag line 10 between tail 30 and head 20. A number of spacers 40 may be unlimited as the spacers may be a deformable, non-conductive, and porous material that allows ionic conduction while preventing direct electrical contact between the drag and power line 10 and pipe walls 50. A second end of power and drag line 10 may extend out from a side of head 20 opposite from spacers 40 a length of about 10 ft to about 5280 ft. Power and drag line 10 extending out from side of head 20 may be insulated so as to prevent electrical contact between extended power and drag line 10 and pipe walls 50. Head 20 may include a first soft poly ball and a leading reference electrode 25. Tail 30 may include a second soft poly ball and a following reference electrode 35. Leading reference electrode 25 and following reference electrode 35 may include a reference piece of copper or silver (a dissimilar metal than pipe walls 50) and a porous plug of vycor glass or may be any other type of reference electrode. Tail 30 may include a second soft poly ball and a following reference electrode 35. Spacers 40 may be formed from a non-conducting material and may insulate power and drag line 10 from pipe walls 50. Spacers 40 may be porous and allow treatment fluid 70 to flow through spacers 40. Spacers 40 may be constructed from a non-conductive mesh and may be in the shape of offset wedges or any other spacer shape which may support power and drag line 10 at a position approximately at a central axis of pipe walls 50. Spacers 40 may be comprised of thick, porous, and flexible layers of material that allow ionic conduction through fluid 70 while preventing direct contact between power and drag line 10 and the pipe walls 50 Spacers 40 may prevent power and drag line 10 from making direct contact with pipe walls 50.

Treatment fluid 70 may be placed within pipe walls 50. Treatment fluid 70 may include ions 75 from one or more metal salts based on a metal of pipe walls 50. Treatment fluid 70 may include ions 75 from one or more metal salts suitable for plating onto iron and compatible alloys of iron, and species that are suitable for anodizing aluminum, alloys of aluminum, or other non-ferrous metals and alloys. Metal salts may be selected so as to not be corrosive to pipe walls 50. Treatment fluid 70 may include ions 75 from metal salts including copper sulfate, nickel sulphate, nickel chloride, iron (II) ammonium sulphate, etc. and may have an ion concentration from 1 ppb to a saturation limit of the salt. Treatment fluid 70 may provide anodizing treatment baths for aluminum and other non-ferrous tube material systems.

Head 20, tail 30, and spacers 40 may be sized based on an interior diameter of pipe walls 50. An interior diameter of pipe walls 50 may be any diameter under 3 inches. Pipe walls 50 may be constructed from iron or iron alloy, nickel or nickel alloy, aluminum or aluminum alloy, titanium, stainless steel, copper, and similar tube systems that are coated or protected by organic, ceramic, or metallic coating systems that are either passive or actively/sacrificially providing surface protection of the tube wall from corrosion, fatigue, fraction, or abrasion or combinations of these deterioration mechanisms. Electroplating apparatus 60 may be pulled by power and drag line 10 through treatment fluid 70 within pipe walls 50 at a rate from 1 ft/min to 100 ft/min. Power and drag line 10 may have an applied voltage 15. Power and drag line 10 may be insulated along areas that do not fall between in the head 20 and tail 30 so as to prevent electrical contact between power and drag line 10 and pipe walls 50.

Treatment fluid 70 surrounding electroplating apparatus 60 within pipe walls 50 may be polarized by applied voltage 15 of power and drag line 10 which may cause ions 75 of metal that are floating within treatment fluid 70 to be drawn to pipe walls 50. Applied voltage 15, may be enough voltage to enable ions 75 to plate onto walls of cracks 55, and may be from 0.1 to 50 volts. Ions 75 may be drawn to pipe walls 50 and into any cracks 55 which may exist in pipe walls 50. Ions 75 drawn into cracks in pipe walls 50 may deposit within cracks in pipe walls 50 and may arrest the growth of and/or fill in any cracks 55 in pipe walls 50. System 100 may anodize or electro-wedge ions 75 in cracks 55 of pipe walls 55. System 100 may electroplate pipe walls 50 with a plating thickness of about 5-50,000 nanometers.

Leading reference electrode 25 in head 20 and following reference electrode 35 in tail 30 may be utilized to determine an effectiveness of the treatment of crack in pipe walls 50 by system 100. A multimeter or voltmeter 80 may be connected between the respective signal lines of electroplating apparatus 60 and pipe walls 50. Voltmeter 80 may determine a first voltage difference 85 between leading reference electrode 25 and pipe walls 50 which may be a corrosion potential of untreated pipe walls 50. First voltage difference 85 may be between 0 and 5 volts. Voltmeter 80 may determine a second voltage difference 88 between the following reference electrode 35 and pipe walls 50 which may be a corrosion potential of the treated pipe walls 50. Second voltage difference 88 may be between 0 and 5 volts. First voltage difference 85 and second voltage difference 88 may be utilized to determine if the corrosion potential of pipe walls 50 shifts after system as passed through a given length of pipe walls 50. A corrosion potential shift of pipe walls 50 may be determined based on a difference between first voltage difference 85 and second voltage difference 88 of about 10-500 millivolts. Characteristics of the method including an efficiency and effectiveness factor of treatment by system 100 may be determined based on first voltage difference 85 and second voltage difference 88, a speed or rate that electroplating apparatus 60 is pulled through pipe walls 50, characteristics and concentration of metal ions 75 within treatment fluid 70, and voltage of power and drag lead 10. As described in more detail below, a processor 90 may utilize machine learning to determine an efficiency and effectiveness factor of system 100 and to optimize system 100.

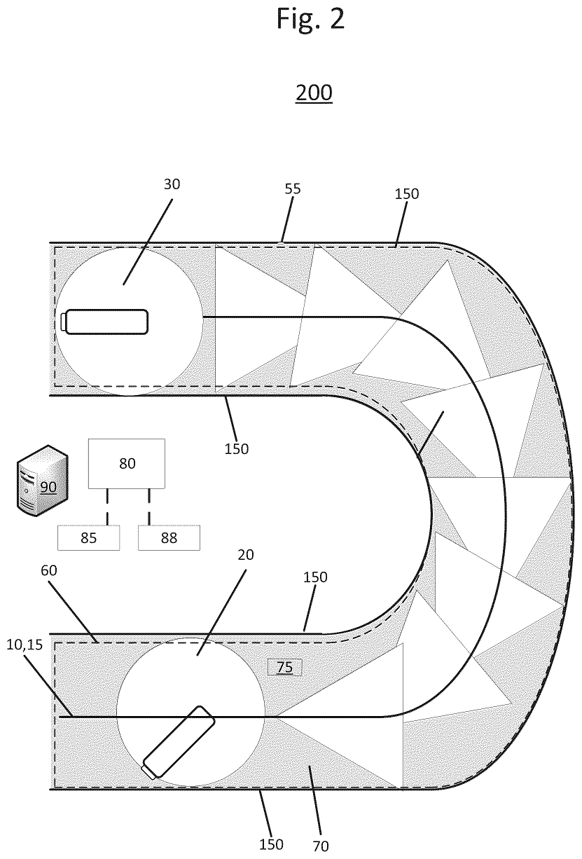

FIG. 2 illustrates an example system to treat cracks in a curved length of tube in accordance with at least some aspects of the present disclosure. Those components in FIG. 2 that are labeled identically to components of FIG. 1 will not be described again for the purposes of brevity.

System 200 may include electroplating apparatus 60, treatment fluid 70, and curved pipe walls 150. Electroplating apparatus 60 may be pulled by power and drag line 10 through treatment fluid 70 within curved pipe walls 150. As shown in FIG. 2, spacers 40 may insulate power and drag line 10 from curved pipe walls 150 by providing support to power and drag line 10 at a position approximately at a central axis of curved pipe walls 150. Spacers 40 may prevent power and drag line 10 from making direct contact with curved pipe walls 150.

Treatment fluid 70 surrounding electroplating apparatus 60 within pipe walls 50 may be polarized by power and drag line 10 which may cause ions 75 of metal that are floating in treatment fluid 70 to be drawn to curved pipe walls 150. Ions 75 may be drawn to curved pipe walls 150 and into any cracks and may arrest cracks and/or fill in cracks in curved pipe walls 150.

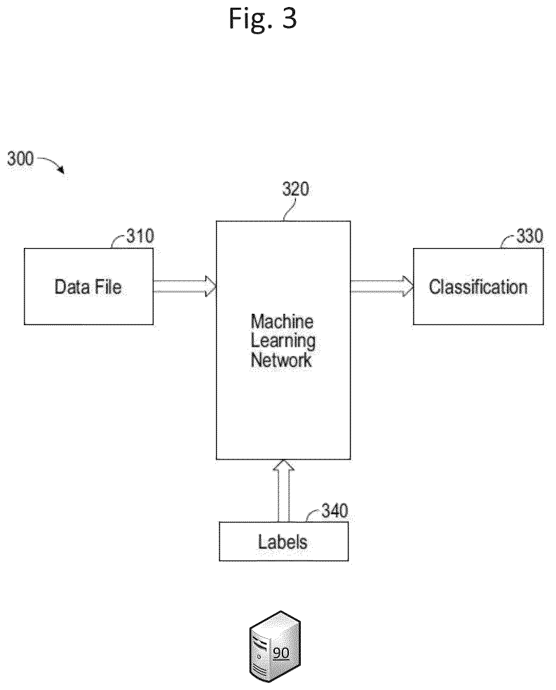

With reference to FIG. 3, a block diagram for a machine learning network 320 for optimizing systems 100 and 200 or developing an analytical model to predict how long a treated crack would remain arrested in accordance with some aspects of the disclosure is shown. In some systems, a machine learning network 320 may include, for example, a convolutional neural network (CNN), a regression and/or a recurrent neural network. A deep learning neural network includes multiple hidden layers. As explained in more detail below, the machine learning network 320 may leverage one or more classification models (e.g., CNNs, decision trees, a regression, Naive Bayes, k-nearest neighbor) to classify data from data files 310. Data files 310 may include first voltage difference 85 and second voltage difference 88 (from FIGS. 1 and 2). The machine learning network 320 may be executed on a processor to optimize systems 100 and 200. The machine learning network 320 may include an algorithm to be executed on a processor to develop an analytical model to predict how long a treated crack would remain arrested. A person of ordinary skill in the art will understand the machine learning network 320 and how to implement it.

In machine learning, a CNN is a class of artificial neural network (ANN). The convolutional aspect of a CNN relates to applying matrix processing operations to localized portions of data, and the results of those operations (which can involve dozens of different parallel and serial calculations) are sets of many features that are delivered to the next layer. A CNN typically includes convolution layers, activation function layers, deconvolution layers (e.g., in segmentation networks), and/or pooling (typically max pooling) layers to reduce dimensionality without losing too many features. Additional information may be included in the operations that generate these features. Providing unique information, which yields features that give the neural networks information, can be used to provide an aggregate way to differentiate between different data input to the neural networks.

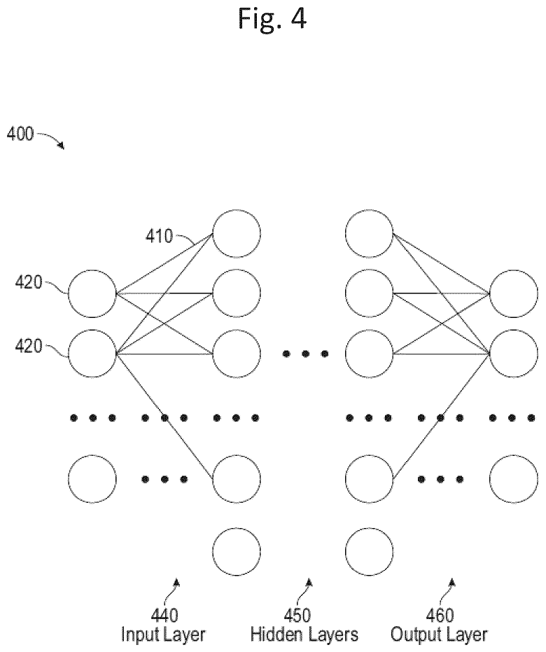

Referring to FIG. 4, generally, a machine learning network 320 (e.g., a convolutional deep learning neural network) includes at least one input layer 440, a plurality of hidden layers 450, and at least one output layer 460. The input layer 440, the plurality of hidden layers 450, and the output layer 460 all include neurons 420 (e.g., nodes). The neurons 420 between the various layers are interconnected via weights 410. Each neuron 420 in the machine learning network 320 computes an output value by applying a specific function to the input values coming from the previous layer. The function that is applied to the input values is determined by a vector of weights 410 and a bias. Learning, in the deep learning neural network, progresses by making iterative adjustments to these biases and weights. The vector of weights 410 and the bias are called filters (e.g., kernels) and represent particular features of the input (e.g., a particular shape). The machine learning network 320 may output logits. Although CNNs are used as an example, other machine learning classifiers are contemplated.

The machine learning network 320 may be trained based on labeling training data to optimize weights. For example, samples of feature data may be taken and labeled using other feature data. In some methods in accordance with this disclosure, the training may include supervised learning or semi-supervised. Persons of ordinary skill in the art will understand training the machine learning network 320 and how to implement it.

An electroplating apparatus in accordance with the present disclosure may mitigate metal fatigue, corrosion fatigue, and stress corrosion cracking in small pipes. An electroplating apparatus in accordance with the present disclosure may arrest small cracks in pipes which are undetectable to visual or non-destructive inspection methods and technologies. An electroplating apparatus in accordance with the present disclosure may treat crack areas in pipes which were inaccessible by previous solutions. A system in accordance with the present disclosure may stop the growth of pipeline cracks remotely, even those that are too small to be detected by borescope cameras (or other means noted above). A system in accordance with the present disclosure may significantly reduce the number of repairs required without changing inspection frequency. A system in accordance with the present disclosure may keep small “undetectable” cracks from growing throughout the service life of a component.

A system in accordance with the present disclosure may reduce the impacts of pipe failures by 50-90% by reinforcing pipeline management processes (that do not detect all cracks) with a technology that stops cracks of all sizes.

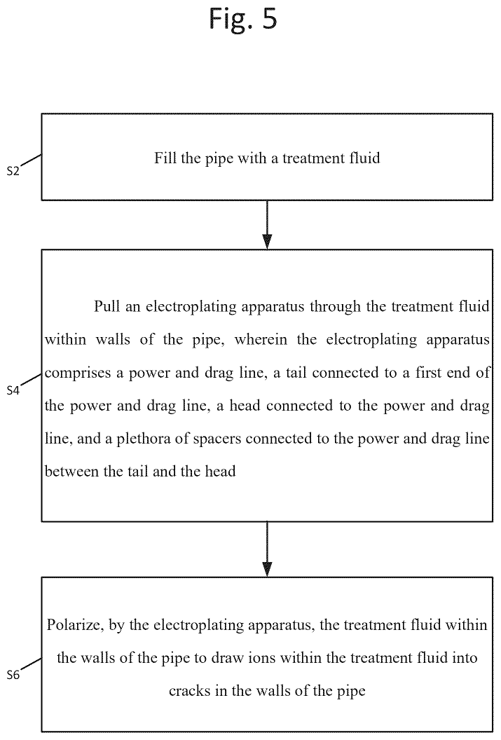

FIG. 5 illustrates a flow diagram for an example method treating cracks in interior walls of a pipe in accordance with at least some aspects of the present disclosure. This example process may include one or more operations, actions, or functions as illustrated by one or more of blocks S2, S4, S6, S8, and/or S10. Although illustrated as discrete blocks, various blocks may be divided into additional blocks, combined into fewer blocks, or eliminated, depending on the desired implementation.

The method may begin at block S2, “Fill the pipe with a treatment fluid.” At block S2, a pipe may be filled with a treatment fluid. The treatment fluid may include ions from one or more metal salts based on a metal of walls of the pipe. The metal salts may be selected so as to not be corrosive to the walls of the pipe walls, so that the plated end product is not corrosive to the base material of the pipe, but actually provides galvanic protection that operates at a low corrosion rate of protection in the vicinity of 1-20 mils per year (where 1 mil=1000^{th} of an inch).

The method may continue from block S2 to block S4, “Pull an electroplating apparatus through the treatment fluid within walls of the pipe, wherein the electroplating apparatus comprises a power and drag line, a tail connected to a first end of the power and drag line, a head connected to the power and drag line, and a plethora of spacers connected to the power and drag line between the tail and the head.” At block S4, an electroplating apparatus may be pulled through the treatment fluid within walls of the pipe. The electroplating apparatus may include a power and drag line, a tail connected to a first end of the power and drag line, a head connected to the power and drag line, and a plethora of spacers connected to the power and drag line between the tail and the head.

The method may continue from block S4 to block S6, “Polarize, by the electroplating apparatus, the treatment fluid within the walls of the pipe to draw ions within the treatment fluid into cracks in the walls of the pipe, and cause them to plate onto the crack wall, or anodize the crack wall interiors with a reactively created film that inhibits crack growth.” At block S6, the electroplating apparatus may polarize the treatment fluid within the walls of the pipe to draw ions within the treatment fluid into cracks in the walls of the pipe.

Finally, the processes and techniques described herein are not inherently related to any apparatus and may be implemented by any suitable combination of components. Further, various types of general-purpose devices may be used in accordance with the teachings described herein. It may also prove advantageous to construct specialized apparatus to perform the method steps described herein. This disclosure has been described in relation to the examples, which are intended in all respects to be illustrative rather than restrictive.

The foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. An apparatus for electroplating interior walls of a pipe, the apparatus comprising:
a power and drag line;
a tail connected to a first end of the power and drag line;
a head connected to the power and drag line; and
a plethora of spacers connected to the power and drag line between the tail and the head;
wherein a second end of the power and drag line extends out from a side of the head opposite the plethora of spacers and when the apparatus is pulled through a pipe by the second end of the power and drag line, the apparatus is configured to polarize a treatment fluid within walls of the pipe to draw ions within the treatment fluid into cracks in the walls of the pipe.

2. The apparatus of claim 1, wherein the head includes a first soft poly ball and a leading reference electrode, and the tail includes a second soft poly ball and a following reference electrode.

3. The apparatus of claim 2, wherein a voltmeter connected between signal lines of the apparatus and walls of the pipe determines a first voltage difference between the leading reference electrode and the pipe walls and a second voltage difference between the following reference electrode and the walls of the pipe.

4. The apparatus of claim 3, wherein an efficiency and effectiveness factor of the apparatus is determined based on a difference between the first voltage difference and the second voltage difference.

5. The apparatus of claim 1, wherein the plethora of spacers are each formed from a non-conducting material and prevent the power and drag line from making direct contact with the walls of the pipe.

6. The apparatus of claim 5, wherein the plethora of spacers are porous and allow the treatment fluid to flow through the spacers.

7. The apparatus of claim 6, wherein the plethora of spacers are in the shape of offset wedges.

8. The apparatus of claim 1, wherein the head, tail and spacers are sized based on an interior diameter of the pipe.

9. An electroplating system for treating cracks in interior walls of a pipe, the system comprising:
a treatment fluid; and
an electroplating apparatus comprising:
a power and drag line;
a tail connected to a first end of the power and drag line;
a head connected to the power and drag line; and
a plethora of spacers connected to the power and drag line between the tail and the head;
wherein a second end of the power and drag line extends out from a side of the head opposite the plethora of spacers and when the apparatus is pulled through a pipe by the second end of the power and drag line, the apparatus is configured to polarize the treatment fluid within walls of the pipe to draw ions within the treatment fluid into cracks in the walls of the pipe.

10. The electroplating system of claim 9, wherein the treatment fluid includes ions from one or more metallic salts.

11. The electroplating system of claim 9, wherein the head includes a first soft poly ball and a leading reference electrode, and the tail includes a second soft poly ball and a following reference electrode.

12. The electroplating system of claim 11, further comprising a voltmeter, wherein the voltmeter is connected between signal lines of the apparatus and the walls of the pipe and determines a first voltage difference between the leading reference electrode and the pipe walls and a second voltage difference between the following reference electrode and the walls of the pipe.

13. The electroplating system of claim 12, further comprising a processor, wherein a machine learning algorithm is executed by the processor to optimize the system.

14. The electroplating system of claim 9, wherein the plethora of spacers are each formed from a non-conducting material and prevent the power and drag line from making direct contact with the walls of the pipe.

15. The electroplating system of claim 14, wherein the plethora of spacers are porous and allow the treatment fluid to flow through the spacers.

16. The electroplating system of claim 9, wherein the head, tail and spacers are sized based on an interior diameter of the pipe.

17. A method of treating cracks in interior walls of a pipe, the method comprising:
filling the pipe with a treatment fluid;
pulling an electroplating apparatus through the treatment fluid within walls of the pipe, wherein the electroplating apparatus comprises:
a power and drag line;
a tail connected to a first end of the power and drag line;
a head connected to the power and drag line; and
a plethora of spacers connected to the power and drag line between the tail and the head; and
polarizing, by the electroplating apparatus, the treatment fluid within the walls of the pipe to draw ions within the treatment fluid into cracks in the walls of the pipe.

18. The method of claim 17, wherein the head includes a first soft poly ball and a leading reference electrode, and the tail includes a second soft poly ball and a following reference electrode, the method further comprises:
determining, by a voltmeter, a first voltage difference between the leading reference electrode and the pipe walls; and
determining, by the voltmeter, a second voltage difference between the following reference electrode and the walls of the pipe.

19. The method of claim 18, further comprising determining an efficiency and effectiveness factor of the electroplating apparatus based on a difference between the first voltage difference and the second voltage difference.

20. The method of claim 19, further comprising executing, by a processor, a machine learning algorithm to optimize the electroplating apparatus efficiency and effectiveness.
